(19) United States
(12) Patent Application Publication
(10) Pub. No.: US 2005/0130532 A1
(43) Pub. Date: Jun. 16, 2005

(54) Patterned glass fiber textile

(76) Inventors: Lennart J. Brandel, Helsingborg (SE); Per-Olof Georg Algotsson, Akarp (SE); Krister Draxo, Helsingborg (SE); Frank Johansson, Oskarstrom (SE); Michaela Klaus, Hasloch (DE); Andrej Kalinay, Trnava (SK)

Correspondence Address: JOHNS MANVILLE;Legal Department, 10100 West Ute Avenue, Littleton, CO, 80127, US

(21) Appl. No.: 10/736,117

(22) Filed: Dec. 15, 2003

(51) Int. Cl. B32B 5/02; B32B 27/12; B32B 27/04; D03D 15/00

(52) U.S. Cl. 442/189; 442/101; 442/103; 442/108; 264/301

(57) ABSTRACT

Provided is a woven, patterned glass fiber textile comprised of a warp yarn having a titer in the range of from 10 to 125 tex, and a weft yarn having a titer in the range of about 68 to 660 tex. The resulting textile fabric is aesthetically pleasing, and finds excellent applicability as a wallcovering.

### BACKGROUND OF THE INVENTION

1. Field of the Invention

The present invention relates to a glass fiber textile fabric which is aesthetically pleasing, and finds particular applicability as a fabric for wall coverings. More specifically, the present invention relates to a method for the production of a patterned glass fiber textile using a Jacquard weaving process.

2. Description of the Related Art

Looms, such as Dobby looms, have been used for many decades in order to produce glass fabrics. This is also true for the production of fabrics woven with glass fiber yarns. However, a difficulty has been found in producing aesthetically pleasing glass fabrics, and particularly glass fabrics which contain a pattern. Generally, glass fabrics are used as reinforcement, and its aesthetic qualities are not important. However, the application of glass fiber textiles to wall coverings has increased the demand for aesthetically pleasing glass fiber fabrics, and particularly those which can be efficiently prepared using a loom.

Glass fabrics woven with a pattern on a loom are known. For example, see U.S. Pat. No. 6,267,151, issued to Andre Moll of Vitrulan Textil Glas GmbH. In the Moll patent, a method is described for producing a patterned glass fabric, especially suitable for wallpaper or similar materials having a fabric woven with glass fiber yarns. The glass fiber yarn has a titer between 130 tex and 150 tex, and preferably between 139 tex and 142 tex, which is used for the warp. A glass fiber yarn with a titer between 190 tex and 400 tex, and preferably of 215 tex, is used as the filling in the fabric. The yarn is generally processed on a pattern controlled Jacquard loom. It is noted in the patent that the processing of glass fibers on Jacquard machines has never been previously successful, but states that by adhering to the specific limiting values of the glass fiber yarns used that patterned glass fabrics can be produced.

The importance of aesthetics in commercial products such as wall coverings, however, require that more flexibility is provided in creating patterns in woven glass textile fabrics. The demand is such that an inability to weave patterned glass fiber textiles on a Jacquard loom using a variety of glass fiber yarns, much greater than that offered by Moll in U.S. Pat. No. 6,267,151, becomes an obstacle to commercial acceptance. Accordingly, additional flexibility in creating patterned glass fiber textiles, and the discovery of such flexibility, would be greatly welcome in the industry.

Accordingly, it is an object of the present invention to produce a glass textile fabric which is aesthetically pleasing and has been prepared on a Jacquard loom.

Another object of the present invention is to provide a process for preparing a patterned glass fiber textile useful in wallcoverings which is able to be woven on a Jacquard loom using glass fiber yarns for the warp which are much smaller than have heretofore been employed.

These and other objects of the present invention will become apparent to the skilled artisan upon a review of the following disclosure.

### SUMMARY OF THE INVENTION

In accordance with the foregoing objectives, the present invention provides a glass fiber textile which is aesthetically pleasing and is patterned. The textile is prepared using a Jacquard weaving process. The fabric is woven with a glass fiber yarn having a titer of from 10 to 125 tex in the machine direction or warp. The fiberglass yarn used as the weft or cross direction is in the range of from about 68 to 660 tex.

For among other factors, the present invention is based upon the discovery that a patterned glass fiber textile can be successfully woven using a Jacquard loom when the warp yarn is in the range of from 10 to 125 tex. Such textiles find particular applicability as a fabric for wallcoverings.

### DETAILED DESCRIPTION OF THE PREFERRED EMBODIMENTS

The warp yarn used in the woven, patterned glass fiber textile of the present invention has a titer in the range of between 10 and 125 tex. More preferably, the glass fiber yarns used for the warp have a titer in the range of from 30 to 75 tex, and most preferably about 34 tex, or 70 tex. The warp density of the textile, which can be suitably used as a wallcovering, generally ranges from 2.5 to 20 threads/cm., and is preferably in the range of from about 2.5 to 5 threads/cm., with about 3.15 threads/cm. being most preferred as the warp density.

The weft yarn used together with the warp yarn can have a titer in the range of from 68 to 660 tex. More preferably, the titer of the glass fiber yarn used as the weft or cross direction yarn is in the range of from 190 to 350 tex, and is more preferably about 200 tex or about 330 tex. The weft yarn density of the textile ranges from 2.0 to 12 threads/cm., and is more preferably about 2.4 threads/cm. or 5.0 threads/cm.

The glass fiber textiles of the present invention, employing the warp yarns and weft yarns described above, are prepared on a Jacquard loom. Such Jacquard looms are well-known, and are used because of their patterned controls. It has been found that glass fiber textiles can in fact be woven on a Jacquard loom using the warp yarns and weft yarns in combination as described above to provide a beautifully woven, patterned glass fiber textile. The glass yarns used as the warp yarn and weft yarn, can be comprised of sliver, super sliver, continuous yarn, roving, or texturized yarn, as long as the particular warp and weft titer are met. Sliver, which can be characterized as a staple fiber strand or a discontinuous fiber yarn, is well-known, and is described, for example, in Fiber Glass, by J. Gilbert Mohr and William P. Rowe, 1978, van Nostrand Rinehold Company, which is hereby incorporated by reference in its entirety. The production of sliver using the so-called “drum attenuation” method is also described and referenced in U.S. Pat. No. 4,863,502, which is also hereby incorporated by reference in its entirety. The use of sliver or a texturized yarn are preferred for either the warp yarn or weft yarn in the weaving of the patterned glass fiber textile of the present invention on a Jacquard loom.

The glass types used in the manufacture of the glass fiber yarns are preferably C-glass or E-glass. Such chemical glass or electronic glass compositions are well-known in the industry.

The woven, patterned glass fiber textile of the present invention is aesthetically pleasing to the sight and touch, and is thereby suitable as wallcoverings. While the patterned effect of the textile is pleasing, at times additional color within the pattern may be desired. In such cases, mixing synthetic resin yarns in with the glass fiber yarns, especially for the weft, has been found to allow one to provide additional color to the textile. Such synthetic resin fibers are well-known, and include polyesters among others. The synthetic resin fibers can be dyed to impart the color desired.

Once the patterned glass fiber textile has been woven on the Jacquard loom, the textile can be used as is, or is preferably coated/impregnated in conventional fashion to provide the final characteristics of the product. Chemical treatments of glass fabrics are known to finalize/adjust such characteristics as strength, volume, stability and opacity of the final textile product. Any such chemical treatments can be employed with regard to the glass fiber textile of the present invention.

In a preferred embodiment, the woven textile of the present invention is impregnated with a chemical formulation comprised of a starch binder, a synthetic polymeric binder, or a wet enhancer/cross linker. The starch binder is preferably a potato starch, but also can be any suitable starch derived from other types of plant or crop materials, e.g., corn starch. The polymeric binder employed is preferably characterized by a low T_{g}. Such synthetic binders can be based on vinyl acetate, and can be latex binders. The wet enhancer or cross linker can be either an organic or inorganic material which enhances the wet properties of the final textile product. Use of a cross linker as well, generally an inorganic cross linker such as ammonium zirconium carbonate, can improve the effect that the starch binder/polymeric binder has on the overall textile product by stabilizing the chemical mixture upon application.

The chemical formulation used to impregnate or coat the woven textile is preferably water-based, and will in general have a dry substance percentage of between 5 and 20 weight percent, and preferably between 10 and 20 weight percent in the chemical bath. Pigments, either white or colored pigments, can also be added or used to create color fabrics. A typical chemical formulation, calculated on a dry basis, is comprised of from 20 to 60 weight percent starch binder, from 30 to 60 weight percent polymeric binder, from 0 to 20 weight percent of the wet enhancer/cross linker, and from 0 to 20 weight percent of other components such as pigments.

The chemical formulation is applied to the textile by use of any appropriate impregnation or coating technique. Such techniques which are preferred include a rotary printing or a padding technique. Following the impregnation, the fabric may be conveyed to a drying means, which can be steam heated cylinders, air dryers, or any other suitable drying means which would not adversely impact the final textile material.

Having described preferred embodiments of the invention, it is to be understood that the invention is not limited to those precise embodiments, and that various changes and modifications may be effected therein by one skilled in the art without departing from the scope or spirit of the invention as defined in the appended claims.

1. A woven, patterned glass fiber textile comprised of a glass fiber yarn with a titer of from 10 to 125 tex as the warp, and a glass fiber yarn having a titer ranging from 68 to 660 tex as the weft.

2. The glass textile fabric of claim 1, wherein the titer of the warp yarn is in the range of from about 30 to 75 tex.

3. The glass textile fabric of claim 1, wherein the titer of the warp yarn is about 34 tex.

4. The glass textile fabric of claim 1, wherein the titer of the warp yarn is about 70 tex.

5. The glass textile fabric of claim 1, wherein the titer of the weft yarn is in the range of from 190 to 350 tex.

6. The glass textile fabric of claim 1, wherein the titer of the weft yarn is about 200 tex.

7. The glass textile fabric of claim 1, wherein the titer of the weft yarn is about 330 tex.

8. The glass textile fabric of claim 1, wherein the warp density of the textile fabric ranges from 2.5 to 20 threads/cm.

9. The glass textile fabric of claim 8, wherein the warp density of the textile wallcovering is in the range of from about 2.5 to 5 threads/cm.

10. The glass textile fabric of claim 1, wherein the weft yarn density of the textile is in the range of from about 2.0 to 12 threads/cm.

11. The glass textile fabric of claim 1, wherein the textile is impregnated with a chemical formulation comprised of a starch binder and a polymeric binder.

12. A method of making a woven, patterned glass fiber textile comprising the following steps:
providing a patterned control Jacquard loom,
using a glass fiber warp yarn with a titer from 10 to 125 tex, and
using a glass fiber weft yarn with a titer ranging from 68 to 660 tex.

13. The method of claim 12, wherein the titer of the glass fiber warp yarn ranges from 30 to 75 tex.

14. The method of claim 12, wherein the titer of the glass fiber warp yarn is about 34 tex.

15. The method of claim 12, wherein the titer of the glass fiber warp yarn is about 70 tex.

16. The method according to claim 12, wherein the titer of the weft yarn ranges from about 190 to 350 tex.

17. The method of claim 12, wherein the warp density of the textile ranges from 2.5 to 5 threads/cm.

18. The method of claim 12, wherein the weft yarn density ranges from about 2.0 to 12 threads/cm.

19. The method of claim 12, wherein the textile is further impregnated with a chemical formulation comprised of a starch binder and a polymeric binder.
